(19) United States
(12) Patent Application Publication
(10) Pub. No.: US 2023/0258156 A1
(43) Pub. Date: Aug. 17, 2023

(54) SYSTEM AND METHOD FOR ATTACHING A WIND TURBINE BLADE COMPONENT TO A WIND TURBINE BLADE SHELL PART

(71) Applicants: LM WIND POWER A/S, Kolding (DK); BLADE DYNAMICS LIMITED, Eastleigh Hampshire (GB)

(72) Inventors: Thomas NYTOFT, Kolding (DK); Christian NIELSEN, Kolding (DK); Jeppe ANDERSEN, Kolding (DK); Johnny ERIKSEN, Kolding (DK); Paul Damian Michael TODD, Eastleigh Hampshire (GB)

(21) Appl. No.: 18/017,940

(22) PCT Filed: Sep. 9, 2021
(86) PCT No.: PCT/EP2021/074776

§ 371 Date: Jan. 25, 2023

(30) Foreign Application Priority Data
Sep. 10, 2020 (GB) 2014252.7

(51) Int. Cl. F03D 13/10; B29C 65/78; B29C 65/00; B29D 99/00

(52) U.S. Cl. CPC F03D 13/10; B29C 65/7814; B29C 66/532; B29D 99/0028; F05B 2230/604

(57) ABSTRACT

The present invention relates to a system and method for attaching a wind turbine blade component to a surface of a wind turbine blade shell part at a component attachment position. The system comprises a blade shell part support for supporting the blade shell part, a jig comprising a jig base and a component platform for receiving and holding the wind turbine blade component in a first position above at least a part of the blade shell part, the component platform being arranged on the jig base and being at least vertically displaceable relative to the jig base by displacement means to allow the wind turbine blade component to be lowered from the first position to the component attachment position.

### FIELD OF THE INVENTION

The present invention relates to attaching of a wind turbine blade component to a wind turbine blade shell part.

### BACKGROUND OF THE INVENTION

Wind turbines usually comprise a tower, generator, gearbox, nacelle, and one or more rotor blades. The wind turbine blades capture kinetic energy of wind using known airfoil principles. Modern wind turbines may have rotor blades that significantly exceed 100 meters in length.

Wind turbine blades are usually manufactured by forming two shell parts or shell halves from layers of woven fabric or fibre and a resin matrix. Spar caps or main laminates are integrated in the shell halves and may be combined with shear webs or spar beams to form structural support. Spar caps or main laminates are joined to or integrated with the insides of the halves of the shell.

By manufacturing wind turbine blades in segments that can subsequently be joined to form the final blade, some size-related challenges, such as the need for large manufacturing spaces, and challenges related to wind turbine blade transportation may be alleviated.

Currently, pin-joined segmented blades are manufactured by first adhering a complete joint system, such as a pin joint system, in a full-length blade and then cutting the blade into segments that can be handled separately and re-joined at the wind turbine site.

This method has been seen as an unavoidable way of ensuring that two blade segments making up a segmented blade can be made to fit precisely together.

The present invention nevertheless provides a method that makes it possible to manufacture blade segments separately and still obtain a precise fit.

Embodiments of the invention can also be used to attach other types of components to wind turbine blade shell parts with high precision.

### SUMMARY OF THE INVENTION

In a first aspect, the invention provides a system for attaching a wind turbine blade component to a surface of a wind turbine blade shell part at a component attachment position. The system comprises:
a blade shell part support for supporting the blade shell part,
a jig, comprising:
   a jig base,
   a component platform for receiving and holding the wind turbine blade component in a first position above at least a part of the blade shell part, the component platform being arranged on the jig base and being at least vertically displaceable relative to the jig base by displacement means to allow the wind turbine blade component to be lowered from the first position to the component attachment position.

Systems in accordance with the first aspect allow for very precise positioning of a wind turbine blade component on a blade shell part. Precision is crucial in all aspects of wind turbine blades. However, pin joint components must not suffer misalignments, or the blade segments will not fit together. Each of the pin joint components must therefore be attached in the respective blade shell parts in such a way that the blade segments fit precisely together. Very little variance is allowable for pin joint components, which is why segmented blades are currently manufactured by forming the entire blade with the pin joint structure in an assembled state and then cutting the blade into segments. This ensures that the blade segments fit perfectly.

The blade shell part support and the jig are in a fixed positional relationship relative to one another, which ensures that when the component is arranged on the component platform, the position of the component platform relative to the jig base can be translated into a component position relative to the blade shell part support.

As can readily be seen, a factory floor can constitute the jig base. However, in many cases, a separate jig base supported by a floor, such as a factory floor, provides a more flexible system. In such embodiments, the jig can be moved near for instance a mould and be fixated relative to the mould simply by bolting the jig base to the factory floor.

Typically, the surface on which the component is attached is the inner surface of the blade shell part, but it may also be the outer surface, i.e. a surface that faces the surrounding environment when the blade is in production mode.

In some embodiments, the wind turbine blade component is a pin joint receiver box for receiving a corresponding pin joint spar beam. In some embodiments, the wind turbine blade component is a pin joint spar beam for mating with a corresponding pin joint receiver box. However, independent of the purpose of the specific component, embodiments of the system must be carefully configured to handle attachment of the specific component at a specific location on a specific blade shell part to be arranged on a specific blade shell part support. The component platform must be able to engage the component in a well-defined and easily repeatable manner, and the displacement of the component platform, such as an amount of travel, must be suitable for the component and the blade shell part support. In practice, the system is therefore designed taking into account for instance the size and shape of the component and the size and shape of the blade shell part support, among other things.

The component may be moved into a position where it is entirely positioned over the blade shell part, or part of the component may extend outside the blade shell part. This is partly decided by the shape and attachment position of the component. Furthermore, the system must be configured to allow the component in question to be lowered onto the blade shell part.

In some embodiments, the system comprises an adhesive application system for applying an adhesive onto the component before the component is displaced to the component attachment position. The adhesive is added to part of or all of the surface of the component that comes in contact with the blade shell part. Alternatively or in addition, adhesive may be added to the wind turbine blade shell part.

Alternatively or in addition, adhesive is provided by an external system or by personnel, for instance applied to the component and/or the wind turbine blade shell part.

When the component is brought in contact with the adhesive, it may be necessary to provide additional force via the jig, as the adhesive may have a high viscosity that requires a relatively high force to be displaced.

In some embodiments, the jig comprises position control means configured to limit a movement of the component platform relative to the jig base. This may for instance be a motorized precision drive configured to allow the component platform to be stopped at one or more predefined positions relative to the jig base.

In some embodiments, the component platform is supported by the jig base at least via a track system configured to allow the component platform to be displaced relative to the jig base along a track defined by the track system. The track may for instance comprise a linear track and/or a curved track. In some embodiments, the component platform is supported entirely by a track system arranged on the jig base.

The track system may include one or more track stops configured to stop the component platform at corresponding one or more predefined positions. This allows for stopping the component platform at predefined positions relative to the jig base with a high precision.

In some embodiments, the displacement means comprises an actuator system comprising one or more actuators. The displacement means may for instance comprise one or more hydraulic actuators in the actuator system. In addition, or alternatively, the displacement means may for instance comprise one or more stages, such as linear stages.

In some embodiments, the component platform and the jig base are interconnected via at least one of the one or more actuators. In some embodiments, the platform to which the component is attached may not be directly connected to the jig base. Rather, the component platform may be separated from the jig base for instance via a track as described above. In some embodiments, the actuators are connected to the jig base. In some embodiments, they are attached to an intermediate carrier, which is in direct contact with the jig base.

As previously mentioned, the jig base and the blade shell part support are arranged in a fixed positional relationship relative to one another, at least during the attaching of the component to the blade shell part. In some embodiments, the jig base is firmly attached to or integrated with the blade shell part support, such as in a permanent manner. In some embodiments, the jig is movable relative to the blade shell part support and is fixated at the appropriate position relative to the blade shell part support, for instance by bolting the jig base to a floor.

In some embodiments, the component platform comprises biasing means configured to bias the wind turbine blade component to a predefined position relative to the component platform. For instance, the component platform may comprise grooves that can engage with corresponding members on the component, such as protruding members that can mate with the grooves to provide a well-defined resting position of the component on the component platform. This ensures easy and repeatable positioning, in particular well-defined positioning, of the component. This may be seen as a self-aligning component positioning system.

In some embodiments, the component platform comprises fastening means for temporarily fixating the wind turbine blade component to the component platform. This improves personnel safety. Furthermore, when the component is to be attached to the blade shell part using a highly viscous adhesive, the force exerted onto the component by the blade shell part and adhesive might cause the component to disengage from the component platform or at least shift relative to the component platform, which may compromise the precision with which the component is to be attached.

In some embodiments, the component platform comprises a male member for mating with and holding a pin joint receiver box. This is particularly effective when the wind turbine blade component is a pin joint receiver box for receiving a corresponding pin joint spar beam.

In some embodiments, the male member has an adjustable cross-sectional width and/or cross-sectional height, whereby the male member can be adjusted to engage precisely with a range of pin joint receiver boxes of different cross-sectional width and/or cross-sectional height. This makes the same system easily configurable to handle a range of pin joint receiver boxes, as opposed to having to replace the male member to allow the system to be reliably used with different receiver boxes.

In some embodiments, a wind turbine blade shell mould for manufacturing a wind turbine blade shell part is used as the blade shell part support in the system.

In some embodiments, the jig is configured such that the component platform can be displaced to a position not above the blade shell part support. This is advantageous for instance when the jig is arranged next to a blade shell part mould used for manufacturing a blade shell part. By allowing the component platform to be displaced away from the mould, it can be moved so it is not in the way when personnel manufacture the blade shell part, e.g. when laying up fibre and/or when resin is or is to be infused, in particular when a vacuum bag is to be arranged around the mould before resin infusion.

A second aspect of the invention provides a method for attaching a wind turbine blade component to a surface of a wind turbine blade shell part at a component attachment position. The method comprises:
providing a jig, comprising:
   a jig base,
   a component platform for receiving and holding the wind turbine blade component in a first position above at least a part of the blade shell part, the component platform being arranged on the jig base and being at least vertically displaceable relative to the jig base by displacement means to allow the wind turbine blade component to be lowered from the first position to the component attachment position,
providing an adhesive on the blade shell part at the component attachment position,
lowering the wind turbine blade component into contact with the adhesive,
curing the adhesive, and
releasing the wind turbine blade component from the component platform.

The features and considerations discussed in relation to the first aspect may also apply with respect to the second aspect, mutatis mutandis.

In some embodiments, the method comprises, between the step of fixating the wind turbine blade component on the component platform and the step of providing the adhesive on the blade shell part at the component attachment position, steps of:
lowering the component into the component attachment position,
marking at least a part of, such as all of, an outline of the component onto the blade shell part,
moving the component platform away from the component attachment position,
providing the adhesive substantially within the outline of the component, thereby reducing an amount of superfluous adhesive.

An advantage of this approach is that adhesive is not provided where unnecessary. This minimizes usage of adhesive.

In some embodiments, the jig is configured to provide an adhesive on the blade shell part at the component attachment position and/or onto at least part of a surface of the component that will come into contact with the blade shell part in the component attachment position. This may for instance be achieved using robot means, controlled to detect where to apply adhesive, for instance by way of a contact sensor or a vision sensor. Alternatively, the robot means may be pre-programmed with a geometry of at least a part of the component and with a procedure for applying the adhesive onto the component.

As an alternative, an adhesive is applied only to the surface of the component as opposed to providing adhesive on the blade shell part at the component attachment position. Providing the adhesive on the component may reduce the amount of adhesive used, since adhesive is only applied to the area of the component that is attached to the blade shell part. However, due to the already high precision of the system and method, adhesive can readily be applied very precisely on the blade shell part. The marking step described above is one way to ensure this.

### BRIEF DESCRIPTION OF THE DRAWINGS

The invention is explained in detail below with reference to embodiments shown in the drawings.

FIG. 1 is a schematic view of a wind turbine.

FIG. 2 is a schematic view of a wind turbine blade.

FIG. 3 is a schematic view of a segmented wind turbine blade.

FIG. 4 is a schematic view of a tip segment for a segmented wind turbine blade.

FIG. 5 is a schematic view of a root segment for a segmented wind turbine blade.

FIG. 6 is a schematic view of a spar beam for a pin joint in a segmented wind turbine blade.

FIG. 7 is a schematic view of a receiver box for a pin joint in a segmented wind turbine blade.

FIG. 8 is a schematic view of a pin joint receiver box mated with a corresponding pin joint spar beam.

FIGS. 9-14 illustrate an embodiment of the present invention.

FIGS. 15-21 illustrate another embodiment of the present invention.

### DETAILED DESCRIPTION OF SELECTED EMBODIMENTS

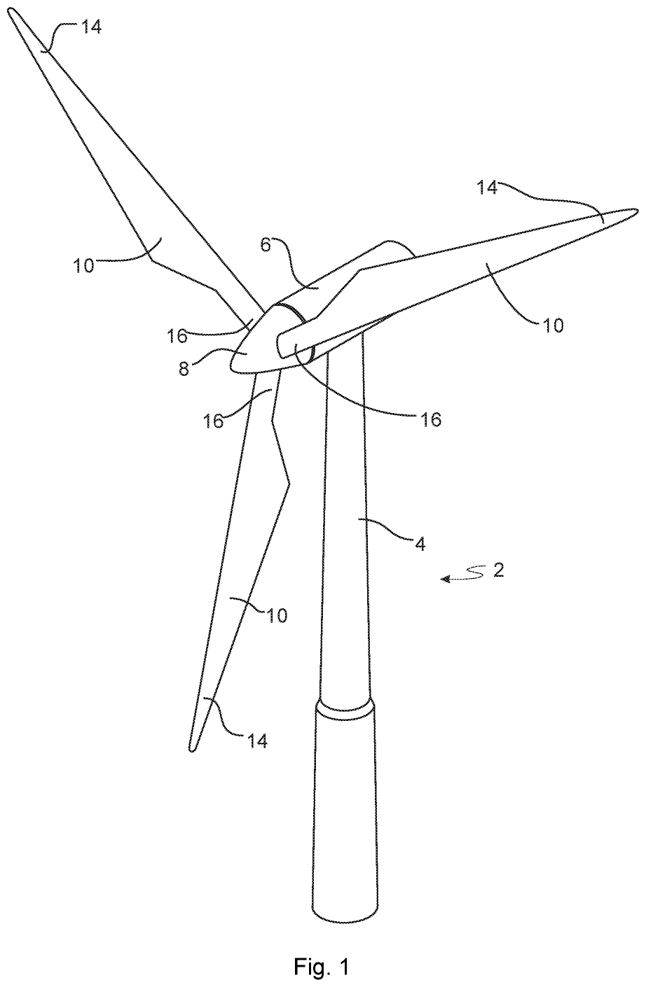

FIG. 1 illustrates a conventional modern upwind wind turbine 2 according to the so-called “Danish concept” with a tower 4, a nacelle 6 and a rotor with a substantially horizontal rotor shaft. The rotor includes a hub 8 and three blades 10 extending radially from the hub 8, each having a blade root 16 nearest the hub and a blade tip 14 farthest from the hub 8. The rotor has a radius denoted R.

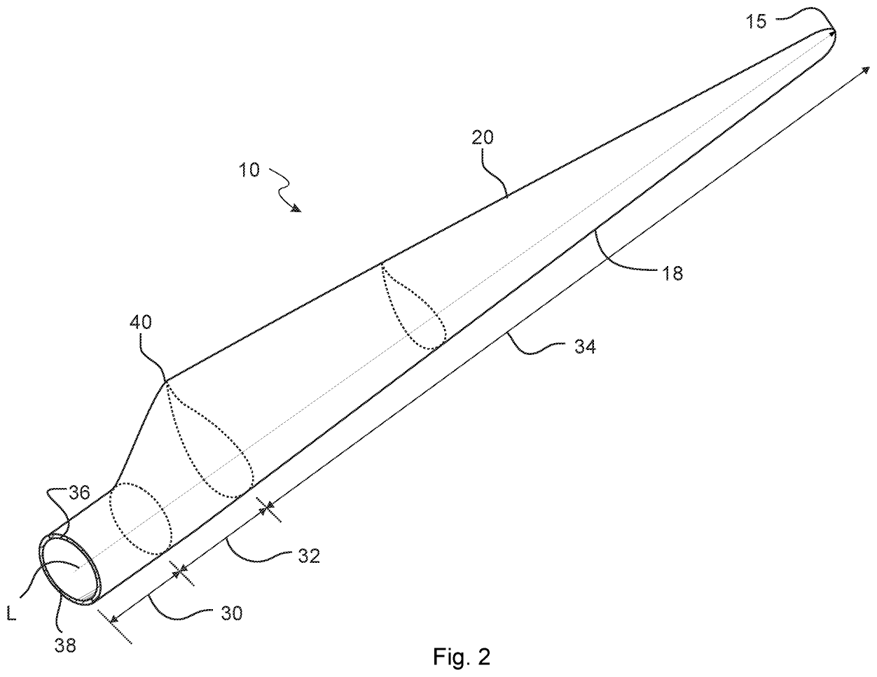

FIG. 2 shows a schematic view of a wind turbine blade 10. The wind turbine blade 10 has the shape of a conventional wind turbine blade and comprises a root region 30 closest to the hub, a profiled or an airfoil region 34 farthest away from the hub and a transition region 32 between the root region 30 and the airfoil region 34. The blade 10 comprises a leading edge 18 facing the direction of rotation of the blade 10, when the blade is mounted on the hub, and a trailing edge 20 facing the opposite direction of the leading edge 18. The outermost point of the blade 10 is the tip end 15.

The airfoil region 34 (also called the profiled region) has an ideal or almost ideal blade shape with respect to generating lift, whereas the root region 30 due to structural considerations has a substantially circular or elliptical cross-section, which for instance makes it easier and safer to mount the blade 10 to the hub. The diameter (or the chord) of the root region 30 may be constant along the entire root area 30. The transition region 32 has a transitional profile gradually changing from the circular or elliptical shape of the root region 30 to the airfoil profile of the airfoil region 34. The chord length of the transition region 32 typically increases with increasing distance r from the hub. The airfoil region 34 has an airfoil profile with a chord extending between the leading edge 18 and the trailing edge 20 of the blade 10. The width of the chord decreases with increasing distance r from the hub.

A shoulder 40 of the blade 10 is defined as the position where the blade 10 has its largest chord length. The shoulder 40 is typically provided at the boundary between the transition region 32 and the airfoil region 34. FIG. 2 also illustrates the longitudinal extent L of the blade.

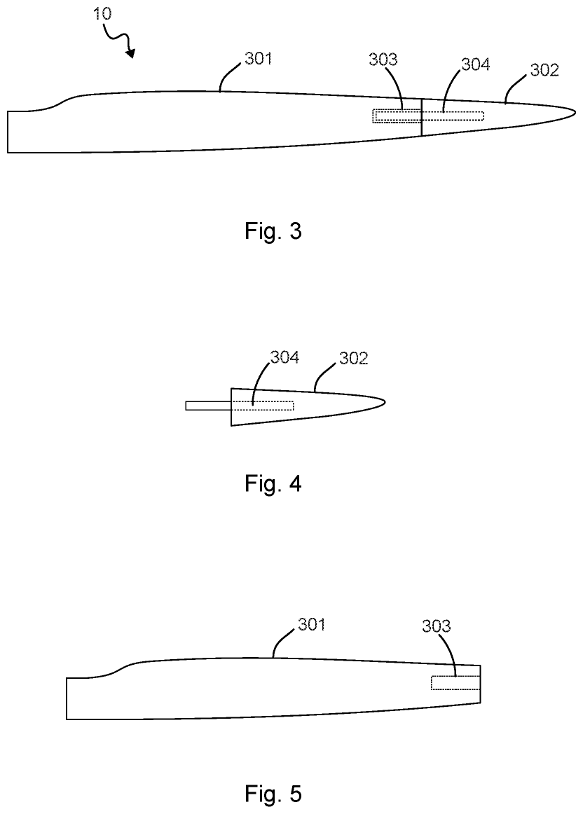

FIG. 3 illustrates schematically a segmented wind turbine blade 10. It is made up at least of a root segment 301 and a tip segment 302. To allow joining of the root segment 301 with the tip segment 302, the two segments 301, 302 may comprise a receiver box 303 and a mating spar beam 304. The receiver box and spar beam are fixed together for instance with a pin.

FIG. 4 illustrates the tip segment 302 of the segmented blade 10 shown in the previous figures. Aside from the shell that forms the aerodynamic profile of the blade, the tip segment further comprises the spar beam 304 as described above. The spar beam 304 of the tip segment extends beyond (outside) the tip segment shell to allow the spar beam to engage with a corresponding receiver box 303 arranged in the root segment 301.

FIG. 5 illustrates the root segment 301 of the segmented blade 10. As described above, the root segment comprises a receiver box 303 for receiving the spar beam 304 of the tip segment 302 in order to allow the root segment and the tip segment to be securely joined together. The final blade is obtained by mating the spar beam 304 with the receiver box 303, securing the two together, sealing the region where the blade segments meet, and providing any finishing touches to the blade.

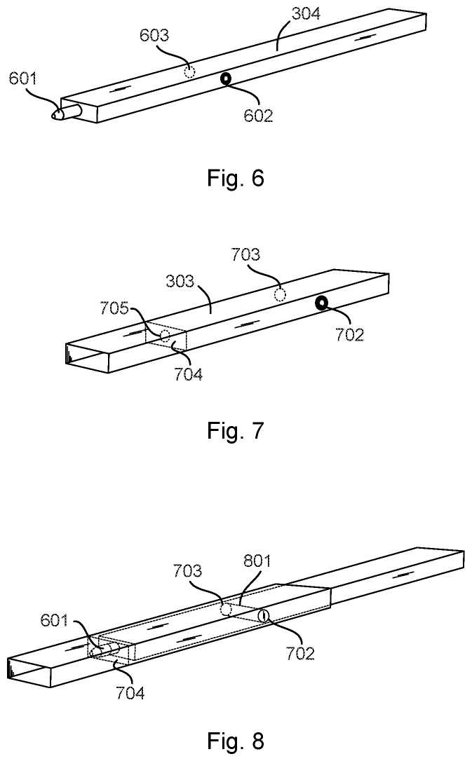

FIG. 6 is a schematic illustration of a spar beam 304 for a pin joint for a segmented wind turbine blade. In addition to the beam as such, the pin joint spar beam has holes 602, 603 for receiving a pin. Furthermore, this spar beam 304 has a bolt 601 that will engage with a slot in the receiver box to improve stability. This contributes to reducing unwanted motion between the spar beam 304 and the receiver box 303 during use.

FIG. 7 is a schematic illustration of a receiver box 303 for engaging with the spar beam 304 shown in FIG. 6. Like the spar beam 304, the receiver box 303 comprises holes 602, 603 for receiving a pin. The receiver box furthermore comprises a bolt slot plate 704 with a slot 705 configured to fit tightly with the bolt 601 of the spar beam 304. When the bolt is engaged with the slot plate, chordwise movement of the spar beam relative to the receiver box is inhibited.

The slot plate 704, slot 705, the position of holes 602, 603, 702, 703, and the shape and size of the spar beam 304 and the receiver box 303 are not essential for the present invention. Furthermore, the hole—pin system is also just one way of fixing together a receiver box and a spar beam.

FIG. 8 shows the receiver box 303 and spar beam 304 engaged, with the spar beam 304 inserted in the receiver box 303, and the bolt 601 engaged with the bolt slot 705 in the receiver box bolt slot plate 704. The pin 801 shown schematically in FIG. 8 engages with holes 602, 603, 702, 703 to ensure the tip segment and the root segment are maintained connected under centrifugal/centripetal forces.

Given the fine tolerances required to provide a secure and durable joint, the spar beam 304 and receiver box 303 must be attached in the respective shell parts 301, 302 with great precision, as discussed above. Systems and methods in accordance with the present invention provide ways to achieve this precision while allowing the segmented blade to be manufactured as two parts from the start, as opposed to present methods, in which the entire blade is manufactured and then cut into segments.

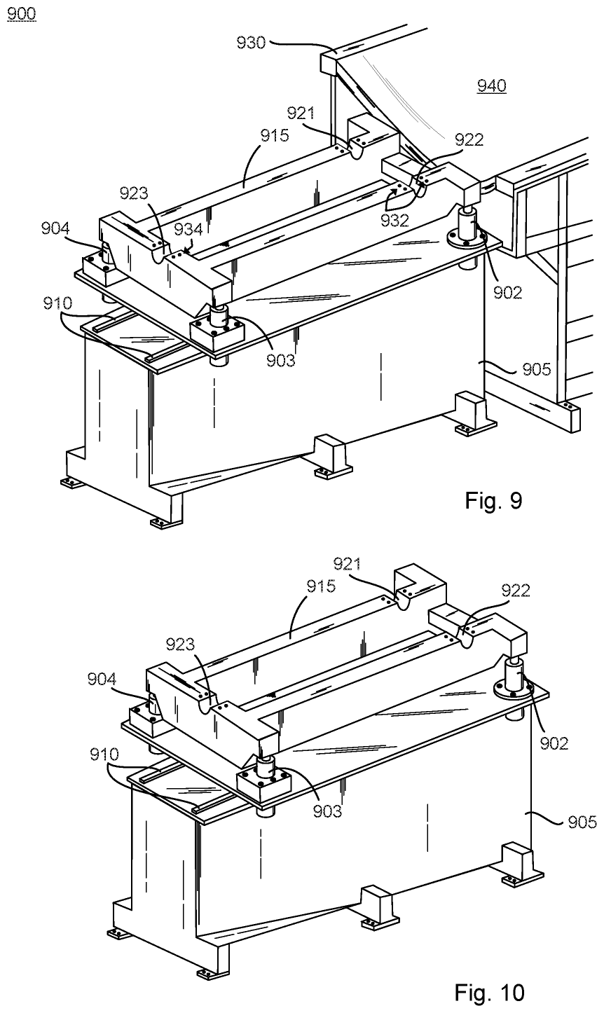

FIG. 9 illustrates a system 900 in accordance with an embodiment of the present invention. The system 900 comprises a blade shell part support 930 for holding a blade shell part 940, a component platform 915 for holding the component, and a jig base 905 supporting the component platform 915. The component platform 915 is moveable relative to the jig base 905, in this case with a vertical displacement provided by hydraulic cylinders 902, 903, 904 (and a non-visible further hydraulic cylinder) and a horizontal displacement provided by a track system 910. The component platform 915 comprises grooves 921, 922, 923 for holding a spar beam 304 in a fixated position while the spar beam 304 is being attached to the blade shell part 940. Fastening means such as holes 932 (and corresponding holes around grooves 921 and 923) allow for securing the spar beam to the component platform 915 using clamps.

In FIG. 9, the component platform is in a raised configuration and located abutting the blade shell part support 930.

The blade shell part 940 may for instance be a blade shell part for a tip segment such as the tip segment 302 illustrated in FIGS. 3-4.

The component platform 915 in FIG. 9 is particularly suited for a spar beam for a pin joint. The component platform 915 comprises a seat into which a spar beam can be placed, for instance using a crane.

FIG. 10 illustrates the jig separate from the blade shell part mould 930. As can be seen from FIGS. 9 and 10, the jig may be fastened to the ground in order to keep it from moving during use.

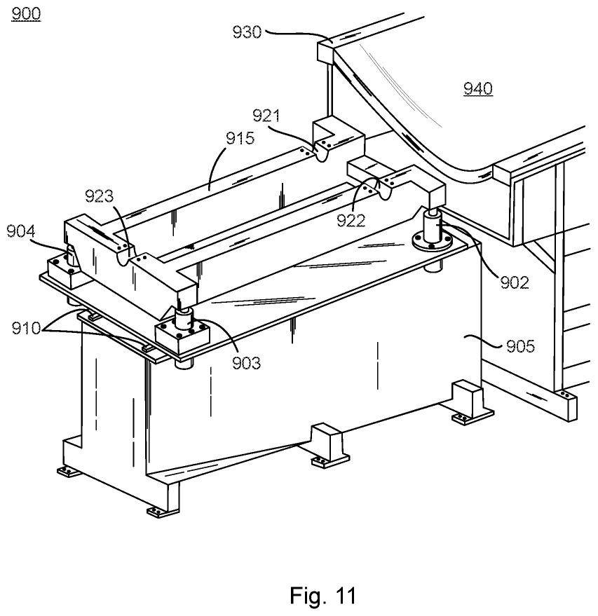

FIG. 11 illustrates the jig with the component platform in a retracted state in which the component platform is moved away from the support 930. In some embodiments, the support 930 is a blade shell part mould in which a blade shell part is manufactured. The track 910 allows the platform 915 to be moved away from the support 915, allowing personnel to work more freely around the support 930 while manufacturing the blade shell part 940.

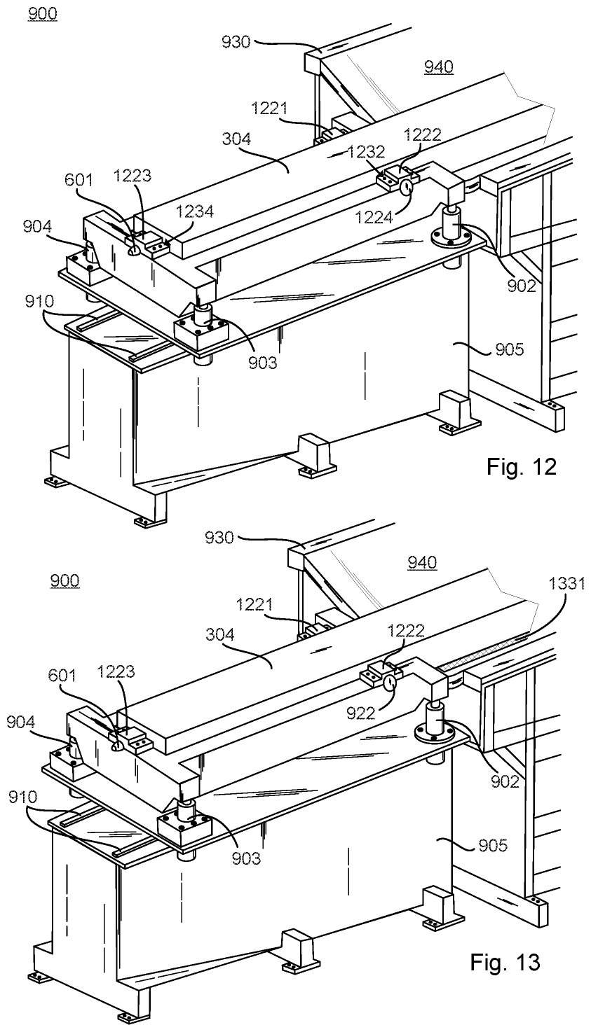

FIG. 12 illustrates the component platform with spar beam 304 placed on it. The spar beam 304 is fixated to the component platform via the bolt 601 and a pin 1224. The pin 1224 goes through the holes 602, 603 illustrated in FIG. 6. Clamps 1221, 1222, 1223 fixate that bolt 601 and pin 1224 to the component platform. The clamps 1221, 1222, 1223 may for instance be attached to the component platform 915 with threaded bolts 1232, 1234 that engage with corresponding threaded holes 932, 934 illustrated in FIG. 9. Holes and bolts are used to hold every clamp 1221, 1222, 1223 in place to secure the spar beam 304 to the component platform.

The bolt 601 cooperating with groove 923 and the pin 1224 cooperating with grooves 921 and 922 also ensure that the spar beam 304 is situated in a very specific position. This ensures that the spar beam 304 is eventually placed with high precision at the desired position on the blade shell part 940.

In FIG. 12 and FIG. 13, the component platform is in a raised position, which provides that there is a space between the blade shell part 940 and the spar beam 304. Accordingly, personnel can add an adhesive 1331 on the blade shell part 940. The component platform could be raised further to provide more access, if needed. Typically, adhesive 1331 is added before the spar beam 304 is placed in the component platform 915. In some embodiments, the component platform has a longer range of travel allowing the component, in this case spar beam 304, to be attached to the component platform 915 clear of the blade shell part support 930. After adding adhesive 1331, the spar beam 304 can be translated to a position over the blade shell part 940 and lowered into the final component attachment position.

The adhesive 1331 eventually bonds the spar beam 304 to the blade shell part.

As additional steps, the spar beam 304 can be lowered before applying the adhesive, and the outline of the spar beam be marked on the blade shell part 940. As a further additional step, the spar beam 304 is raised again before the adhesive is applied. When applying the adhesive, adhesive is only applied inside the marked outline. This helps to prevent application of adhesive where not needed.

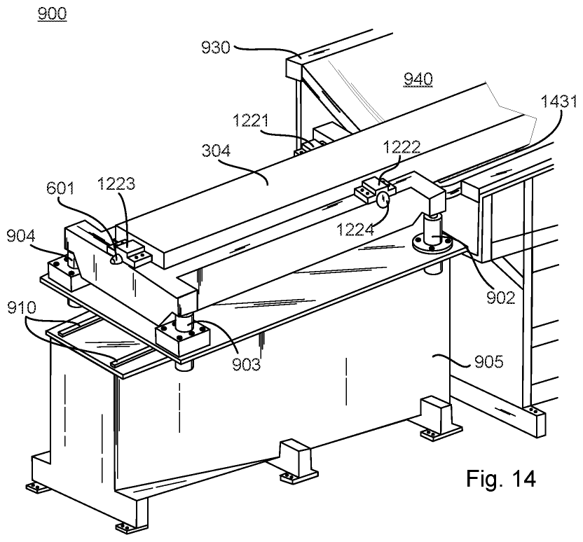

FIG. 14 illustrates that the component platform 915 has been lowered using the hydraulic cylinders 902, 903, 904 and the fourth, not visible, cylinder. This has forced the spar beam 304 into the adhesive 1331 that was applied on the blade shell part 940. Adhesive 1431 is typically forced out from under the spar beam 304 when the spar beam is lowered. It is noted that the spar beam 304 is not lowered all the way to the blade shell part, as this would result in a weaker bond between the component 304 and the blade shell part 940. Thus, the spar beam is lowered to engage with the adhesive without forcing too much of the adhesive out from under the component.

Carefully controlled hydraulic cylinders or stages help position the spar beam precisely into the adhesive on the blade shell part. Such means can easily ensure a precise positioning of the spar beam 304 even if the adhesive is very viscous and hard to displace.

The system described above can help position a spar beam 304 with very high precision in a tip segment 302 (see FIGS. 3 and 4) of a segmented wind turbine blade 10 (see FIG. 3).

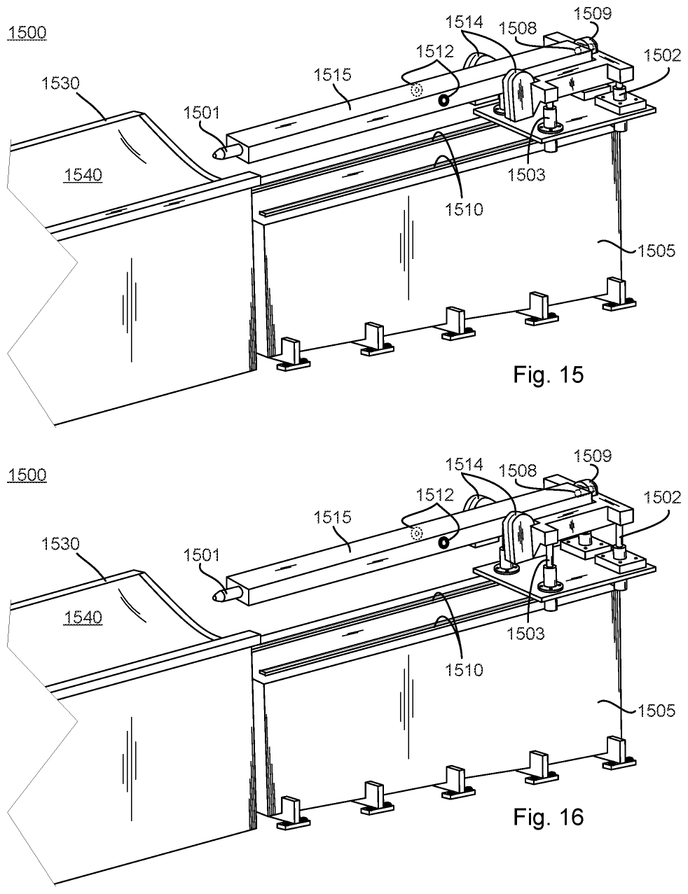

Mirroring the spar beam positioning system 900 illustrated in FIGS. 9-14 and described above, a system 1500 for arranging a receiver box of a pin joint on a root segment shell part is illustrated in FIGS. 15-21 and described below.

FIG. 15 illustrates a system 1500 in accordance with another embodiment of the present invention. The system 1500 comprises a blade shell part support 1530 for holding a blade shell part 1540, a component platform 1515 for holding the component, and a jig base 1505 supporting the component platform 1515. The component platform 1515 is moveable relative to the jig base 1505, in this case with a vertical displacement provided by hydraulic cylinders 1502, 1503 (and two barely visible further hydraulic cylinders) and a horizontal displacement provided by a track system 1510.

In FIG. 15, the component platform 1515 is in a lowered configuration and positioned away from the blade shell part support 1530.

The component platform 1515 in FIG. 15 is particularly well-suited for attaching a pin joint receiver box to a blade shell part.

As opposed to the embodiment 900, which is particularly suited for attaching a spar beam 304 to a blade shell part, the component platform 1515 in the system 1500 comprises a male member suitable for holding the receiver box 303 to be placed on the blade shell part 1540.

The component platform 1515 resembles a spar beam 304 to a large extent in order to cooperate precisely with the receiver box 303 during attachment of the receiver box 303 to the blade shell part 1540.

Similar to the system 900 for attaching a spar beam 304 to a blade shell part 940, the system 1500 in FIG. 15 has a track that allows for displacing the component platform 1515 to and away from the blade shell part 1540. Due to the male member 1515 for engaging with the receiver box 303, the track 1510 is substantially longer compared to the track used in the system 900 for attaching a spar beam 304.

In this example, the component platform 1515 comprises holes 1512 configured to engage with the receiver box 303 via a pin to hold the receiver box 303 in a well-defined position relative to the component platform. This ensures that the position of the receiver box is well controlled and the receiver box secured, which in turn allows the receiver box 303 to be attached at the attachment position with high precision, which is required for the root segment to join precisely with the tip segment comprising the spar beam 304.

In the present example, the component platform is easily replaceable. It is fixed to a carrier by way of spar beam fasteners 1514 and clamp 1509. The spar beam fasteners in this example are configurable to engage and disengage with holes in the component platform 1515. The clamp 1509 uses the same principle as fasteners 1221, 1222, and 1223 for fixating the spar beam 304 as shown in FIG. 12. That is, the clamp 1509 is clamped by inserting bolts into holes in the component platform 1515. As illustrated with dashed lines, the component platform 1515 has a bolt 1508 similar to bolt 1501 shown in FIG. 15 and bolt 601 illustrated in FIGS. 6, 8, and 12-14. The bolt 1508 is clamped by clamp 1509.

FIG. 16 illustrates the component platform 1515 in a raised position, which is achieved by extending the hydraulic cylinders, including hydraulic cylinders 1502, 1503. This provides workspace around the male member 1515, which is necessary in order to attach the receiver box 303 to the component platform 1515.

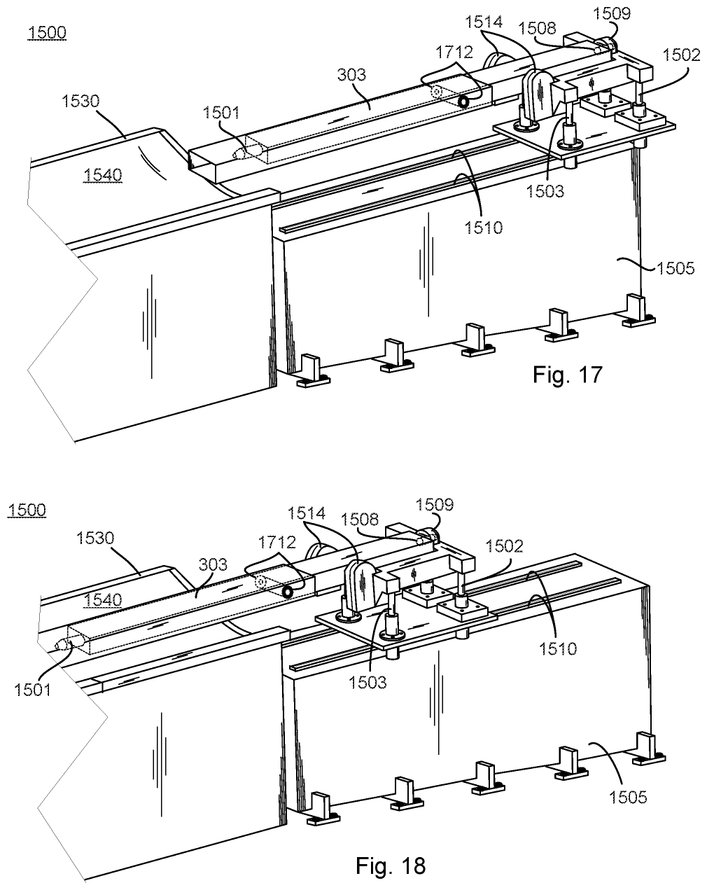

FIG. 17 illustrates a receiver box 303 that has been engaged with the component platform 1515. This is achieved for instance using a crane. Fastening means 1712, such as a pin extending between holes 1512 (see e.g. FIG. 16), ensures that the receiver box 303 is placed in a well-defined position relative to the component platform 1515. (For simplicity, the slot plate 704 illustrated in FIGS. 7 and 8 is not illustrated in FIGS. 17 and 18.) The component platform is in a raised position in FIG. 17. Depending on the shape of the blade shell part 1540 and the shape of the receiver box 303, it may or may not be possible to use a pin for attaching the receiver box 303 to the component platform 1515. Instead, shorter pin-like members may be inserted at each side of the component platform to ensure that the receiver box 303 and the component platform 1515 are correctly aligned.

FIG. 18 illustrates the component platform 1515 having been displaced towards the blade shell part support 1530 as part of the process of bringing the receiver box 303 into its attachment position. This has been achieved by displacing the component platform via the track 1510.

FIG. 19 illustrates the receiver box 303 in a position above the blade shell part 1540, and an adhesive 1931 placed on the blade shell part 1540. The adhesive 1931 could also be added before the receiver box 303 is displaced to a position above the blade shell part. Furthermore, as described in relation to the system 900, the receiver box can be lowered to the attachment position before adding the adhesive, and an outline can be added to indicate where adhesive is required. In FIG. 19, adhesive 1931 has been added on the blade shell part 1540, and the receiver box 303 is located above the blade shell part 1540.

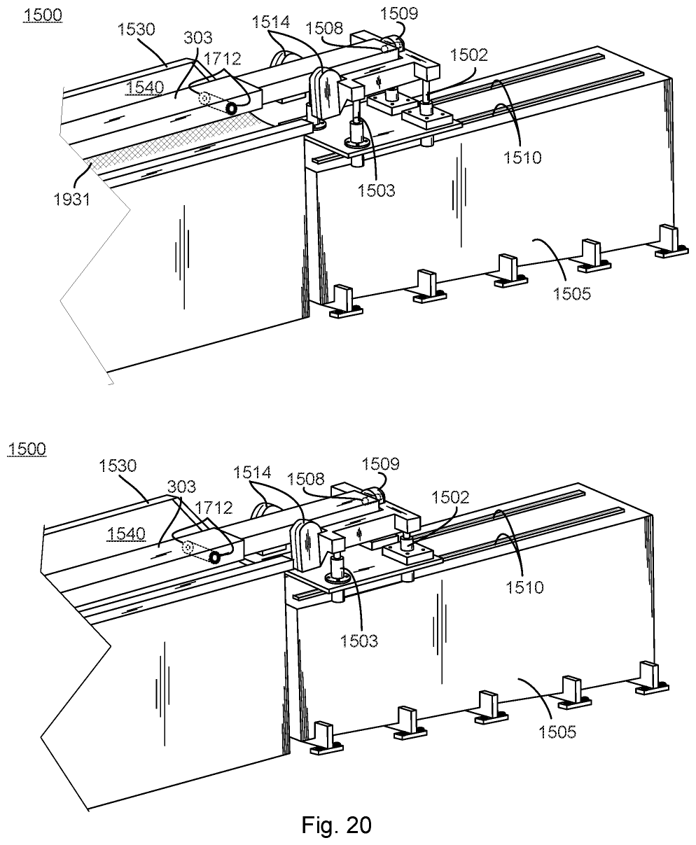

Next, the component platform 1515 is lowered, whereby the receiver box 303 is brought into contact with the adhesive 1931. The hydraulic cylinders, including cylinders 1502 and 1503, ensure that the receiver box is located precisely as required. This final position is illustrated in FIG. 20. Like the embodiment 900, the system 1500 ensures that a component, in this case a receiver box 303 for a pin joint, is attached to a wind turbine blade shell part 1540 precisely where it is supposed to be for the receiver box 303 of the root segment 301 to line up precisely with the spar beam 304 of the tip segment 302.

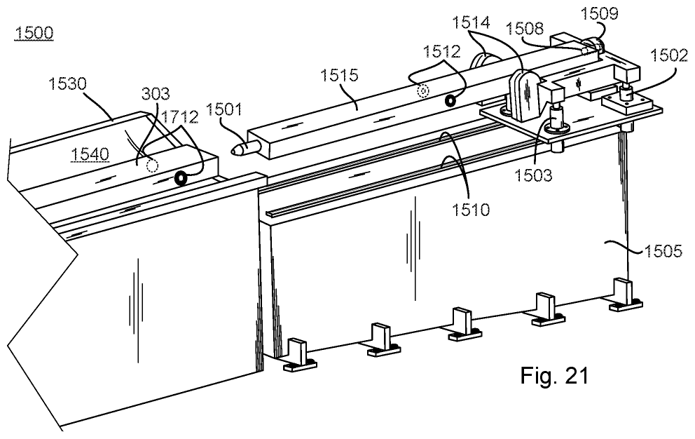

After the receiver box 303 has been attached to the blade shell part 1540, the component platform 1515 is pulled away by displacement along the tracks 1510 with the component platform in the lowered position, as illustrated in FIG. 21.

In accordance with the description above, a spar beam 304 has been precisely attached to a part 940 of a tip segment 302, and a receiver box 303 has been precisely attached to a part 1540 of a root segment 301. This allows blade segments to be manufactured separately.

Although the systems described above are used for attaching pin joint components in blade shell parts, embodiments of the invention may also be used to attach other types of components, such as shear webs, precisely on blade shell parts.

The invention is not limited to the embodiments described herein and may be modified or adapted without departing from the scope of the claimed invention.

### LIST OF REFERENCE NUMERALS

2: wind turbine
4: tower
6: nacelle
8: hub
10: blades
14: blade tip
15: tip end
16: blade root
18: leading edge
20: trailing edge
30: root region
32: transition region
34: airfoil region
36: pressure side shell part
38: suction side shell part
40: blade shoulder
301: root segment
302: tip segment
303: pin joint receiver box
304: pin joint spar beam
601: bolt
602, 603, 702, 703: pin hole
704: bolt slot plate
705: bolt slot
801: joint pin
900: spar beam jig
902, 903, 904: lowering means, hydraulic cylinder
905: jig base
910: rails, track
915: component platform
921, 922, 923: fastening recess
930: blade shell part support, blade shell mould
932, 934: threaded holes
940: blade shell part
1221, 1222, 1223: component clamps
1224: fastening pin
1232, 1234: fastening means, threaded bolt
1331, 1431: adhesive
1500: receiver box jig
1501: bolt
1502, 1503: lowering means, hydraulic cylinder
1505: jig base
1508: bolt
1509: clamp
1510: rails, track
1512: pin hole
1514: spar beam fastener
1515: component platform, male member
1530: blade shell part support
1540: blade shell part
1712: fastening means
1931: adhesive

1. A system (900, 1500) for attaching a wind turbine blade component (303, 304) to a surface (940, 1540) of a wind turbine blade shell part (940, 1540) at a component attachment position, the system comprising:
a blade shell part support (930, 1530) for supporting the blade shell part,
a jig, comprising:
i. a jig base (1505),
ii. a component platform (915) for receiving and holding the wind turbine blade component in a first position above at least a part of the blade shell part, the component platform being arranged on the jig base and being at least vertically displaceable relative to the jig base by displacement means to allow the wind turbine blade component to be lowered from the first position to the component attachment position.

2. A system in accordance with claim 1, wherein the jig comprises position control means configured to limit a movement of the component platform relative to the jig base.

3. A system in accordance with claim 1, wherein the wind turbine blade component is a pin joint receiver box (303) for receiving a corresponding pin joint spar beam.

4. A system in accordance with claim 1, wherein the wind turbine blade component is a pin joint spar beam (304) for mating with a corresponding pin joint receiver box.

5. A system in accordance with claim 1, wherein the component platform is supported by a track system (910, 1510) configured to allow the component platform to be displaced relative to the jig base along a track defined by the track system.

6. A system in accordance with claim 5, wherein the track is a linear track.

7. A system in accordance with claim 5, wherein the track system includes one or more track stops configured to stop the component platform at corresponding one or more predefined positions along the track.

8. A system in accordance with claim 1, wherein the displacement means comprises an actuator system comprising one or more actuators (902, 903, 904, 1502, 1503).

9. A system in accordance with claim 8, wherein the displacement means comprises one or more hydraulic actuators in the actuator system.

10. A system in accordance with claim 8, wherein the component platform and the jig base are interconnected via at least one of the one or more actuators.

11. A system in accordance with claim 1, wherein the jig base and the blade shell part support are arranged in a fixed positional relationship relative to one another.

12. A system in accordance with claim 11, wherein the jig base is firmly attached to or integrated with the blade shell part support.

13. A system in accordance with claim 1, wherein the component platform comprises biasing means (921, 922, 923) configured to bias the wind turbine blade component to a predefined position relative to the component platform.

14. A system in accordance with claim 1, wherein the component platform comprises fastening means (1221, 1222, 1223, 1224, 1232, 1234,1509, 1514) for temporarily fixating the wind turbine blade component to the component platform.

15. A system in accordance with claim 1, wherein the wind turbine blade component is a pin joint receiver box for receiving a corresponding pin joint spar beam, and wherein the component platform comprises a male member (1515) for mating with and holding a pin joint receiver box.

16. A system in accordance with claim 15, wherein the male member has an adjustable cross-sectional width and/or cross-sectional height, whereby the male member can be adjusted to snugly engage with a range of pin joint receiver boxes of different cross-sectional width and/or cross-sectional height.

17. A system in accordance with claim 1, wherein the blade shell part support (930, 1530) is a wind turbine blade shell mould for manufacturing a wind turbine blade shell part.

18. A system in accordance with claim 1, wherein the jig is configured such that the component platform can be displaced to a position not above the blade shell part support.

19. A system in accordance with claim 1, wherein the surface is an inner surface of a wind turbine blade shell part.

20. A method for attaching a wind turbine blade component to a surface (940, 1540) of a wind turbine blade shell part at a component attachment position, the method comprising:
providing a jig, comprising:
i. a jig base,
ii. a component platform for receiving and holding the wind turbine blade component in a first position above at least a part of the blade shell part, the component platform being arranged on the jig base and being at least vertically displaceable relative to the jig base by displacement means to allow the wind turbine blade component to be lowered from the first position to the component attachment position,
providing an adhesive on the blade shell part at the component attachment position,
lowering the wind turbine blade component into contact with the adhesive,
curing the adhesive, and
releasing the wind turbine blade component from the component platform.

21. A method in accordance with claim 20, further comprising, between the step of fixating the wind turbine blade component on the component platform and the step of providing the adhesive on the blade shell part at the component attachment position, steps of:
lowering the component into the component attachment position,
marking at least a part of, such as all of, an outline of the component onto the blade shell part,
moving the component platform away from the component attachment position, providing the adhesive substantially within the outline of the component, thereby reducing an amount of superfluous adhesive.

22. A method in accordance with claim 20, wherein the jig is configured to provide an adhesive on the blade shell part at the component attachment position and/or onto at least part of a surface of the component that will come into contact with the blade shell part in the component attachment position.

23. A method in accordance with claim 20, wherein the surface is an inner surface of a wind turbine blade shell part.
